(19) United States
(12) Patent Application Publication
(10) Pub. No.: US 2014/0067468 A1
(43) Pub. Date: Mar. 6, 2014

(54) METHOD AND APPARATUS FOR SUPPLY RANGE BASED FORECASTING

(71) Applicant: MOTOROLA MOBILITY LLC, Libertyville, IL (US)

(72) Inventors: Brijender S. Marwaha, Vernon Hills, IL (US); Grant S. Hoffman, South Elgin, IL (US); Sheetal R. Shah, Deerfield, IL (US)

(73) Assignee: MOTOROLA MOBILITY LLC, Libertyville, IL (US)

(21) Appl. No.: 13/623,884

(22) Filed: Sep. 21, 2012

Related U.S. Application Data
(60) Provisional application No. 61/693,831, filed on Aug. 28, 2012.

(51) Int. Cl. G06Q 10/08; G06Q 10/04

(52) U.S. Cl. 705/7.31

(57) ABSTRACT

A method (300) and apparatus (200) perform range based forecasting. The method can include receiving (320) at least one description of an end product to be produced by an entity and a forecast demand range for the end product. The method can include determining (330) at least one intermediate product of the end product, where the intermediate product can represent a sub-component of end product. The method can include determining (340) at least one common intermediate product of the at least one intermediate product, where the at least one common intermediate product can be common to different end products. The method can include sending (350) a supply order request range of values representing at least two request quantity values for one order of one shipment of the common intermediate product.

### CROSS REFERENCE TO RELATED APPLICATIONS

This application claims priority from U.S. Provisional Patent Application No. 61/693,831, filed Aug. 28, 2012.

### BACKGROUND

1. Field

The present disclosure is directed to a method and apparatus for supply range based forecasting. More particularly, the present disclosure is directed to providing a supply order range of values for an intermediate product.

2. Introduction

Presently, the production of finished end products often involves the production and use of intermediate products that are parts and sub-components of the end product. A producer of an end product obtains the intermediate products from suppliers. A supplier requires a lead time to produce and deliver the intermediate product to the producer. This adds into the lead time that it takes the producer to produce the end product after a customer places an order. Of course, the customer desires the end product as quickly as possible after placing the order. Thus, a producer desires to reduce the lead time for the intermediate product to reduce the lead time for the end product. To do so, the producer provides a supplier with a forecast demand so the supplier can prepare a corresponding amount of the intermediate products in advance. Unfortunately, the forecast demand is a prediction and may not reflect the actual desired amount of the intermediate product because the customer may place a different order than anticipated. This results in an incorrect amount of production of the intermediate product.

For example, a producer of an electronic device uses a display intermediate from a supplier as a part for production of the electronic device end product. The producer does not know the exact number of electronic devices desired by the consumer. However, to reduce lead time in production of the electronic device, the producer provides a forecast demand to the supplier for the displays so at least some displays are ready faster to reduce the display lead time, which results in reducing the electronic device production lead time. Unfortunately, the forecast demand may not match the number of electronic devices ordered by the customer, which results in an oversupply or undersupply of displays from the supplier.

Thus, there is a need for a method and apparatus for supply range based forecasting.

### SUMMARY

A method and apparatus perform range based forecasting. The method can include receiving at least one description of an end product and a forecast demand range for the end product. The forecast demand range can represent at least two demand quantities of an end product to be produced by an entity. The method can include determining at least one intermediate product of the end product. The intermediate product can represent a sub-component of end product, where the intermediate product is used by the entity to produce the end product. The method can include determining at least one common intermediate product of the at least one intermediate product, where the at least one common intermediate product can be common to different end products. The method can include sending a supply order request range of values representing at least two request quantity values for one order of one shipment of the common intermediate product, where the at least two request quantity values can include a first request quantity value and a second request quantity value, where the first request quantity value is different from the second request quantity value.

### BRIEF DESCRIPTION OF THE DRAWINGS

In order to describe the manner in which advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates an example block diagram of a system in accordance with a possible embodiment;

FIG. 2 is an example illustration of a supply range server according to a possible embodiment;

FIG. 3 is an example flowchart illustrating the operation of the supply range server according to a possible embodiment;

FIG. 4 is an example flowchart illustrating the operation of the supply range server according to a possible embodiment;

FIG. 5 is an example flowchart illustrating the operation of the supply range server according to a possible embodiment;

FIG. 6 is an example flowchart illustrating the operation of the supply range server for a low demand range value according to a possible embodiment;

FIG. 7 is an example flowchart illustrating the operation of the supply range server for a mid-demand range value according to a possible embodiment; and

FIG. 8 is an example flowchart illustrating the operation of the supply range server for a high demand range value according to a possible embodiment.

### DETAILED DESCRIPTION

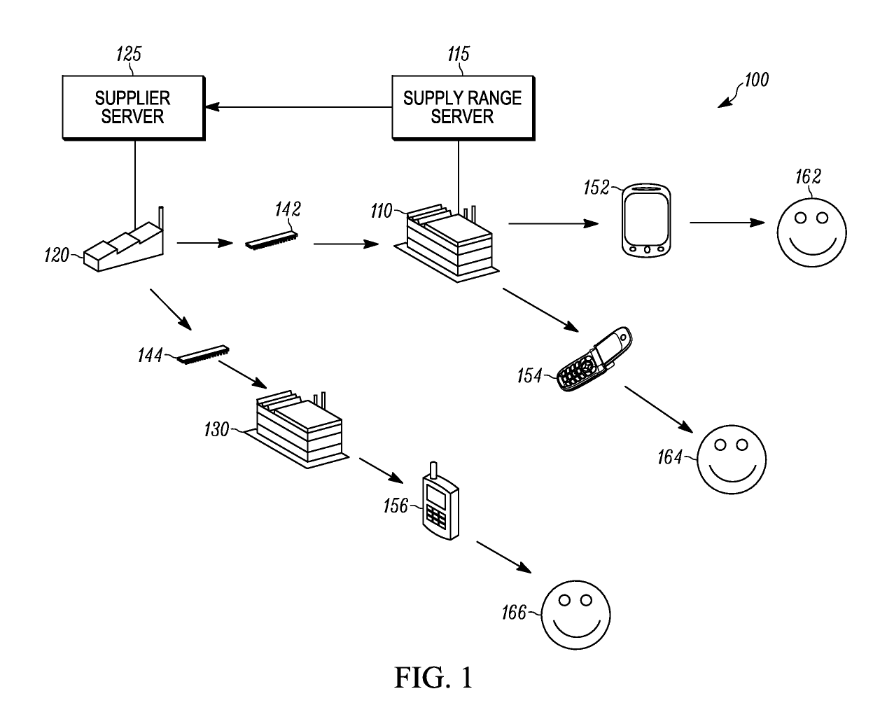

FIG. 1 is an example block diagram of a system 100 according to a possible embodiment. The system 100 can include a producer 110, an supply range server 115, a supplier 120, a supplier server 125, at least one second producer 130, an intermediate product 142, an industry standard intermediate product 144, an end product 152, a second end product 154, a third end product 156, and consumers 162, 164, and 166. The producers 110 and 130 can be manufacturers, such as electronic device, wireless communication device, semiconductor, or automotive manufacturers. The producers 110 and 130 can also be businesses, intermediate suppliers, companies, factories, corporate entities, small business entities, or any other producers that can produce a product. The consumers 162, 164, and 166 can be users, retail operations, other producers, other suppliers, or any other consumers that can obtain a product from the producers 110 and 130.

The supplier 120 can supply an intermediate product 142 to the producer 110. The intermediate product 142 can be a sub-component, such as a part, used by the producer 110 to produce the end product 152. The intermediate product 142 can be a sub-component unique to the end product 152 in that the intermediate product 142 may not have a foreseeable use in a product other than the specific end product 152. The intermediate product 142 can be a sub-component common to different end products. For example, the intermediate product 142 can be a sub-component common to intermediate products in that the intermediate product 142 can be an industry standard intermediate product 144 used to produce different end products 152, 154, and 156 from different producers 110 and 130. The intermediate product 142 can also be a sub-component common to intermediate products in that the intermediate product 142 can be used to produce multiple end products 152 and 154 produced by the same producer 110 or by a subset of producers 110 and 130. Thus, an intermediate product common to different end products can be an industry standard product or can be a product common to multiple products from the producer 110 or from a subset of multiple producers 110 and 130.

In operation according to one embodiment, the supply range server 115 can receive at least one description of an end product 115 and a forecast demand range for the end product 115. The forecast demand range can represent at least two demand quantities of an end product 115 to be produced by an entity, such as the producer 110. The supply range server 115 can determine at least one intermediate product 142 of the end product 152. The intermediate product 142 can represent a sub-component of the end product 152, where the intermediate product 142 can be used by the entity to produce the end product 152. The supply range server 115 can determine at least one common intermediate product 142 and/or 144 of the at least one intermediate product 142. The at least one common intermediate product 142 and/or 144 can be common to different end products 152, 154, and/or 156. The supply range server 115 can send a supply order request range of values to the supplier server 125. The supply order request range of values can represent at least two request quantity values for one order of one shipment of the common intermediate product 142 and/or 144 from the supplier 120. The at least two request quantity values can include a first request quantity value and a second request quantity value, where the first request quantity value can be different from the second request quantity value.

Embodiments can provide for a range based forecasting process. For example, instead of providing suppliers with a one number forecast or supply request for an intermediate product, a producer can provide the suppliers with a low range, a medium range, and a high range forecast or supply request for the intermediate product. According to an example, the process can take place for components/parts that have a physical lead time of greater than eight weeks for certain electronic devices. However, the actual lead time can depend on the actual end product, the actual intermediate product, and/or other factors.

According to one embodiment a customer 162 and business operations of the producer 110 can determine the demand ranges, including low, mid, and high demand ranges. The ranges can then be loaded into the supply range server 115. For the low range, based on the bill of materials and sub-component intelligence database at the supply range server, the product 152 can be broken down to the level of intermediate products, such as parts and sub-components. These parts and sub-components can then be analyzed into three categories, including industry standard, common with multiple products within the company with healthy future demand, and unique to a single product. If the part and/or sub-component is industry standard then the low range can be flowed out to the supplier 120 for those parts/sub-components, and then the supplier 120 can commit back in the system confirming that if the actual demand for those parts/sub-components fall to or below the low range, then the producer 110 may only be liable to take the low range quantity in that period of time. If the part and/or sub-component is common within multiple products from the producer 110 with healthy future demand then the low range can be flowed out to the supplier 120 on that part/sub-component, and then the supplier 120 can commit back in the system confirming that if the actual demand for that part/sub-component falls to or below the low range then the producer 110 may only be liable to take the low range quantity in that period of time. If the part and/or sub-component is unique to a single product, then the low range can be made equal to the mid-range for that part/sub-component and can be flowed out to the supplier 120 and then the supplier 102 can commit back in the system confirming supply availability for that part/sub-component during that period of time and the producer 110 can commit to the mid-range number.

For the mid-range, based on the bill of materials, the product demand can be broken down into part requirements and, based on the inventory, the supplier 120 can be asked for part requirements for a given period of time. The supplier 120 can then commit back with the supply availability for the requirement in that period of time. Different terms and conditions can be applied to the commitment as it can depend on the supplier, which can be the regular way of forecasting demand and supply.

For the high range, based on the bill of materials and sub-component intelligence database, the product 152 can be broken down to the level of intermediate products, such as parts and sub-components. These parts and sub-components can then be analyzed into three categories including industry standard parts and sub-components, parts and sub-components common with multiple products within the producer 110 with healthy future demand, and parts and sub-components unique to a single product. If a given part and/or sub-component is industry standard or common within multiple products within a producer 110 with healthy future demand, then the high range can be flowed out to the supplier 120 on that part/sub-component, and then the supplier 120 can commit back in the system confirming that if the actual demand for that part/sub-component increases up to or above the high range, then the supplier 120 can assure supply to the high range during a given period of time but, the commit volume may only be to a percentage of the entire part in an extended period of time. Alternately, if the part and/or sub-component is industry standard, then the high range can be flowed out to the supplier 120 on that part/sub-component, and then the supplier 120 can commit back in the system confirming that if the actual demand for that part/sub-component increases up to or above the high range during a given period of time, then the supplier 120 can assure supply to the high range during that period of time, but the commit volume can only be to a percentage of the sub-component in an extended period of time. Alternately, if the part and/or sub-component is industry standard, then the high range can be flowed out to the supplier 120 on that part/sub-component and then the supplier can commit back in the system confirming that if the actual demand for that part/sub-component increases up to or above the high range, then the supplier 120 can assure supply to the high range during a given period of time, but the commit volume can only be to the low or mid-range if demand drops to the low or mid-range or lower.

If the part or sub-component is unique to a single product then further discussions can be held internally at the producer 110 and with the supplier 120. In such as case, one option can be to make the mid-range demand value equal to the high range demand value for the part and flow that value to the supplier 120. In this case, the supplier 120 may only see the mid-range demand value that has artificially been altered to reflect the high range and the mid-range rules can apply. Another option can be to work with the supplier 120 and the high range is flowed out to the supplier 120 on that part/sub-component. Then the supplier 120 can commit back in the system confirming that if the actual demand for those parts/sub-components increases up to or above the high range, then the supplier 120 can assure supply to the high range during a given period of time but the commit volume may only be to a percentage of the part and/or sub-component in an extended period of time. Thus, all the unique materials can be consumed just in an extended period of time. Another option can be, if the producer 110 determines that if there are many unique parts and/or sub-components for the product, then either no high range may be pursued with the supplier 120 or the mid-range is artificially altered to reflect the high range for the entire product and all the mid-range rules can apply. All commitments can be taken into a system, such as the supply ranger server 115, and a material good-to can be generated which feeds back to the starting point where the ranges are generated. For example, a material good-to can be the plan/amount of a product that can be built based on the availability of materials or components.

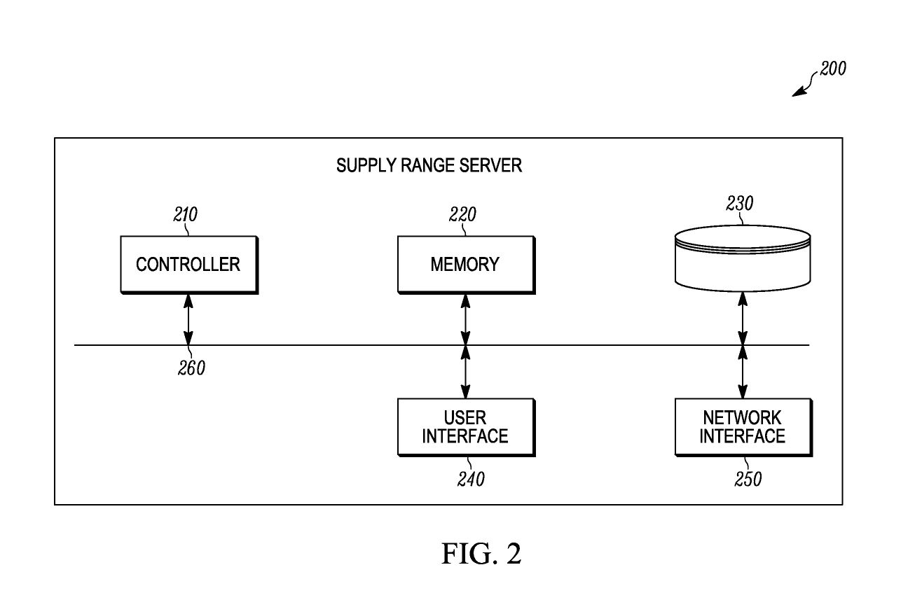

FIG. 2 is an example illustration of a supply range server 200, such as the supply range server 115, according to a possible embodiment. The supply range server 200 can be an apparatus including a controller 210, a memory 220, a database interface 230, a user interface 240, and a network interface 250, all connected through a bus 260. The supply range server 200 may implement any operating system, such as Microsoft Windows®, UNIX, or LINUX, for example. Client and server software may be written in any programming language, such as C, C++, Java® or Visual Basic®, for example. Server software may run on an application framework, such as, for example, a Java® server or .NET® framework

The controller 210 can be any programmed processor. However, operations can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, controller 210 can be any device or devices that are capable of implementing the operations as described in the disclosed embodiments.

The memory 220 may include volatile and nonvolatile data storage, including one or more electrical, magnetic, or optical memories such as a random access memory (RAM), a cache, a hard drive, a flash drive or other memory device. The memory 220 may have a cache to speed access to specific data. The memory 220 may also be connected to a Compact Disc-Read Only Memory (CD-ROM), a Digital Video Disc-Read Only Memory (DVD-ROM), a DVD read write input, a tape drive, or other removable memory device that allows media content to be directly uploaded into the system. The memory 220 may also be located at a remote location, such as over cloud storage. Data may be stored in the memory 220 or in a separate database. The database interface 230 may be used by the controller 210 to access the database.

The user interface 240 may be connected to one or more input and output devices that may include a keyboard, a mouse, a touch screen, speakers, a monitor, a voice-recognition device, or any other device that inputs and/or outputs data. The network interface 250 may be connected to a communication device, a modem, a network interface card, a transceiver, or any other device capable of transmitting and receiving signals from a network, another server, or any other device that transmits and receives signals. For example, the network interface 250 may be used to connect the supply range server 200 to a network or to another server. The components of the supply range server 200 may be connected via an electrical bus 260, may be linked wirelessly, or may be otherwise connected.

Client software and databases may be accessed by the controller 210 from memory 220, and may include, for example, database applications, spreadsheet applications, communication applications, as well as other components that provide for operation of the disclosed embodiments. The supply range server 200 may implement any operating system, such as Microsoft Windows®, LINUX, UNIX, or any other operating system. Although not required, embodiments are described, at least in part, in the general context of computer-executable instructions, such as program modules, being executed by an electronic device, such as a general purpose computer. Generally, program modules can include routine programs, objects, components, and data structures that perform particular tasks or implement particular abstract data types. Moreover, those skilled in the art will appreciate that embodiments may be practiced in network computing environments with many types of computer system configurations, including personal computers, hand-held devices, multi-processor systems, microprocessor-based or programmable consumer electronics, network PCs, minicomputers, mainframe computers, and the like.

In operation, the interface 240 or 250 can receive at least one description of an end product and a forecast demand range for the end product. The forecast demand range can represent at least two demand quantities of an end product to be produced by at least one entity. The controller 210 can determine at least one intermediate product of the end product. The intermediate product can represent a sub-component of end product. The intermediate product can be used by the at least one entity to produce the end product. The controller 210 can determine at least one common intermediate product of the at least one intermediate product. The at least one common intermediate product can be common to different end products. The controller 210 can send a supply order request range of values representing at least two request quantity values for one order of one shipment of the common intermediate product. The at least two request quantity values can include a first request quantity value and a second request quantity value, where the first request quantity value can be different from the second request quantity value. The first request quantity value can be an intermediate product base supply order request value representing a base request quantity of the common intermediate product. The second request quantity value can be an intermediate product variation supply order request value representing a variation request quantity of the common intermediate product.

The controller 210 can determine whether the intermediate product is a product common to at least one product aside from the end product. The controller 210 can send the supply order request range of values including the intermediate product variation supply order request value if the intermediate product is a product common to at least one product aside from the end product. The controller 210 can also determine whether the intermediate product is a unique intermediate product unique to the end product for an intermediate product low supply order request. The controller 210 can send the supply order request range of values including the intermediate product base supply order request value instead of an intermediate product low supply order request value if the intermediate product is a unique product unique to the end product. The controller 210 can determine whether the intermediate product is a unique intermediate product unique to the end product for an intermediate product high supply order request. The controller 210 can send the supply order request range of values including the intermediate product base supply order request value instead of an intermediate product high supply order request value if the intermediate product is a unique product unique to the end product.

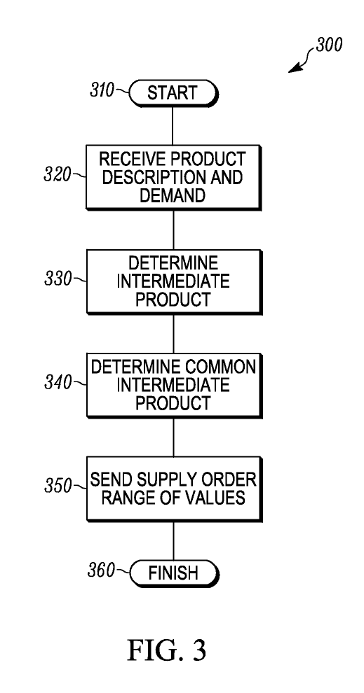

FIG. 3 is an example flowchart 300 illustrating the operation of the supply range server 200 according to a possible embodiment. At 310, the flowchart begins. At 320, the supply range server 200 can receive at least one description of an end product and a forecast demand range for the end product. The forecast demand range can represent at least two demand quantities of an end product to be produced by an entity.

At 330, the supply range server 200 can determine at least one intermediate product of the end product. The intermediate product can represent a sub-component, such as a part, of the end product. The intermediate product can be used by the entity to produce the end product. The intermediate product may also be an intermediate product of an intermediate product. In particular, a first supplier of a first intermediate product may use a second supplier of a second intermediate product that the first supplier uses to produce the first intermediate product. For example, an end product may be a portable communication device, the first intermediate product may be a display that is a sub-component of the portable communication device, and the second intermediate product may include Light Emitting Diodes (LEDs) that are sub-components of the display. As another example, an end product may be an automobile, the first intermediate product may be a tire that is a sub-component of the automobile, and the second intermediate product may be a tire lining material that is a sub-component of the tire. As another example, an end product may be coffee in a cup, the first intermediate product may be the cup that is a sub-component of the coffee in a cup, and the second intermediate product may be a ceramic or paint that is a sub-component of the cup.

At 340, the supply range server 200 can determine at least one common intermediate product of the at least one intermediate product. The at least one common intermediate product can be common to different end products.

At 350, the supply range server 200 can send a supply order request range of values representing at least two request quantity values for one order of one shipment of the common intermediate product from an intermediate product supplier. The at least two request quantity values can include a first request quantity value and a second request quantity value. The first request quantity value can be different from the second request quantity value.

The first request quantity value can be an intermediate product base supply order request value representing a base request quantity of the common intermediate product. The second request quantity value can be an intermediate product variation supply order request value representing a variation request quantity of the common intermediate product. The variation supply order request value can include a high supply order request value higher than the intermediate product base supply order request value or can include a low supply order request value lower than the intermediate product base supply order request value. Both a high supply order request value and a low supply order request value can be sent along with the intermediate product base supply order request value. Thus, the variation supply order request value can be a high range value or can be a low range value, and can also be a mid-range value. For example, the base supply order request value can be relative to the variation supply order request value, can be higher than the variation supply order request value, can be lower than the variation supply order request value, or can be in between multiple variation supply order request values. Thus, the variation supply order request value can be a mid-range value, but can also be a high range value or a low range value.

Continuing with one embodiment, the intermediate product variation supply order request value can be an intermediate product low supply order request value representing a low request quantity of the common intermediate product. The intermediate product low supply order request value can be lower than the intermediate product base supply order request value. At 340, the supply range server 200 can determine whether the intermediate product is an industry standard product for the intermediate product low supply order request value. The supply range server 200 can then send the intermediate product low supply order request value at 350 if the intermediate product is an industry standard product. At 340, the supply range server 200 can also determine whether the intermediate product is a product common to multiple products for the end product producer for the intermediate product low supply order request value. The supply range server 200 can then send the intermediate product low supply order request value if the intermediate product is a product common to multiple products for an end product producer. At 340, the supply range server 200 can also determine whether the intermediate product is a unique intermediate product for the end product produced by the entity. The supply range server 200 can then send the intermediate product base supply order request value as the intermediate product low supply order request value if the intermediate product is a unique product for the end product produced by the entity.

Continuing with another compatible embodiment, the intermediate product variation supply order request value can be an intermediate product high supply order request value representing a high request quantity of the common intermediate product. The intermediate product high supply order request value can be higher than the intermediate product base supply order request value. At 350, the supply range server 200 can send the intermediate product high supply order request value. For example, at step 340, the supply range server 200 can determine whether the intermediate product is an industry standard product. The supply range server 200 can then send the intermediate product high supply order request value if the intermediate product is an industry standard product. The supply range server 200 can then send a commitment to purchase a percentage of the intermediate product high supply order request value number of intermediate products. At 340, the supply range server 200 can also determine whether the intermediate product is an industry standard product. The supply range server 200 can then send an intermediate product supply order request range of values including sending the intermediate product high supply order request value if the intermediate product is an industry standard product. The supply range server 200 can then send a commitment to purchase the intermediate product base supply order request value number of intermediate products.

Continuing with another compatible embodiment, at 340, the supply range server 200 can determine whether the intermediate product is a unique product produced by the entity. The supply range server 200 can then send the intermediate product high supply order request value if the intermediate product is a unique product produced by the entity. The intermediate product high supply order request value can represent an actual intermediate product middle range value. At 340, the supply range server 200 can also determine whether the intermediate product is a unique product produced by the entity. The supply range server 200 can then send the intermediate product high supply order request value if the intermediate product is a unique product produced by the entity. The supply range server 200 can then send a commitment to purchase a percentage of the intermediate product high supply order request value number of intermediate products over a first period of time and a commitment to purchase all of the intermediate product high supply order request value number of intermediate products over an extended second period of time.

According to another compatible embodiment, at 350, the supply range server 200 can send a supply order request range of values representing at least three request quantity values for the common intermediate product. The at least three request quantity values can include a first request quantity value, a second request quantity value, and a third request quantity value. The first request quantity value, the second request quantity value, and the third request quantity value can all be different values. The first request quantity value can be an intermediate product base supply order request value representing a base request quantity of the common intermediate product. The second request quantity value can be an intermediate product low supply order request value representing a low request quantity of the common intermediate product. The intermediate product low supply order request value can be lower than the intermediate product base supply order request value. The third request quantity value can be an intermediate product high supply order request value representing a high request quantity of the common intermediate product. The intermediate product high supply order request value can be higher than the intermediate product base supply order request value. In step 360, the flowchart 300 ends.

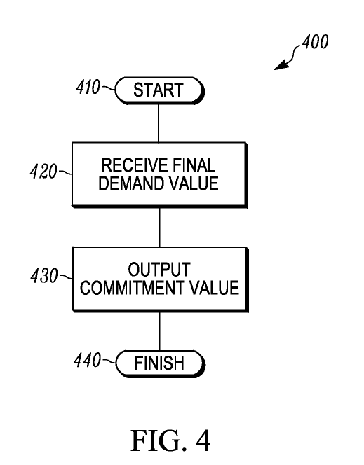

FIG. 4 is an example flowchart 400 illustrating the operation of the supply range server 200 according to a possible embodiment. Elements of the flowchart 400 can be used along with elements of the flowchart 300. At 410, the flowchart 400 begins. At 420, the supply range server 200 can receive a final demand value for the end product. At 430, the supply range server 200 can output a final intermediate product commitment value based on the final demand value. The final intermediate product commitment value can be a commitment to order a quantity of intermediate products. The final demand value and/or the final intermediate product commitment value can be final with respect to demand for the end product with respect to a given order for the intermediate product. Additional orders may be placed for future forecast demand ranges for the end product or future actual demand for the end product. At 440, the flowchart 400 can end.

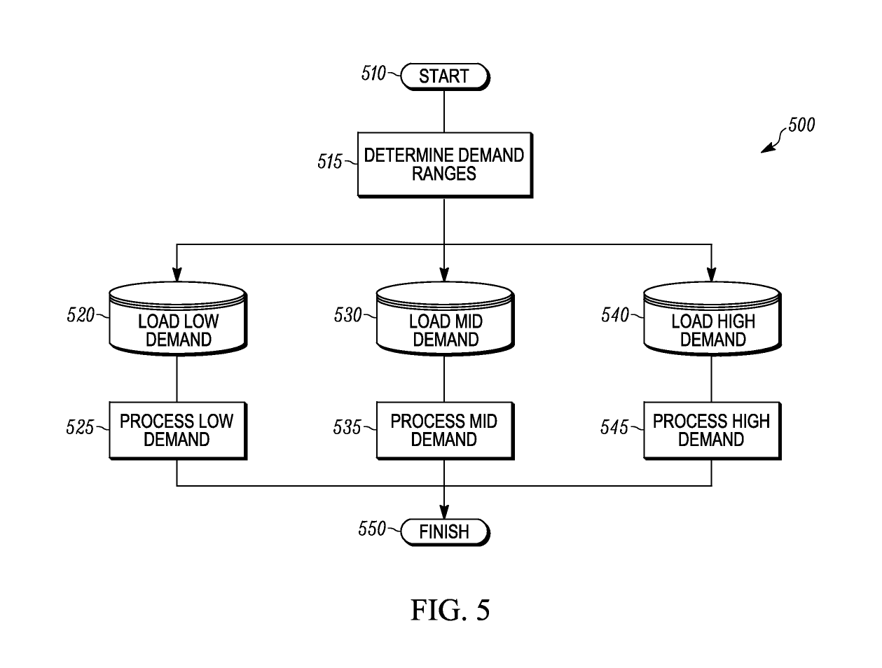

FIG. 5 is an example flowchart 500 illustrating the operation of the supply range server 200 according to a possible embodiment. At 510, the flowchart 500 can begin. At 515, the supply range server 200 can determine demand ranges. For example, the supply range server 200 can receive demand ranges from customer and business operations of an entity or can analyze data to determine demand ranges. At 520, a low demand range value can be loaded. At 525, the supply range server 200 can process the low demand range value. At 530, a mid-demand range value can be loaded. At 535, the supply range server 200 can process the mid-demand range value. At 540, a high demand range value can be loaded. At 545, the supply range server 200 can process the high demand range value. At 550, the flowchart 500 can end.

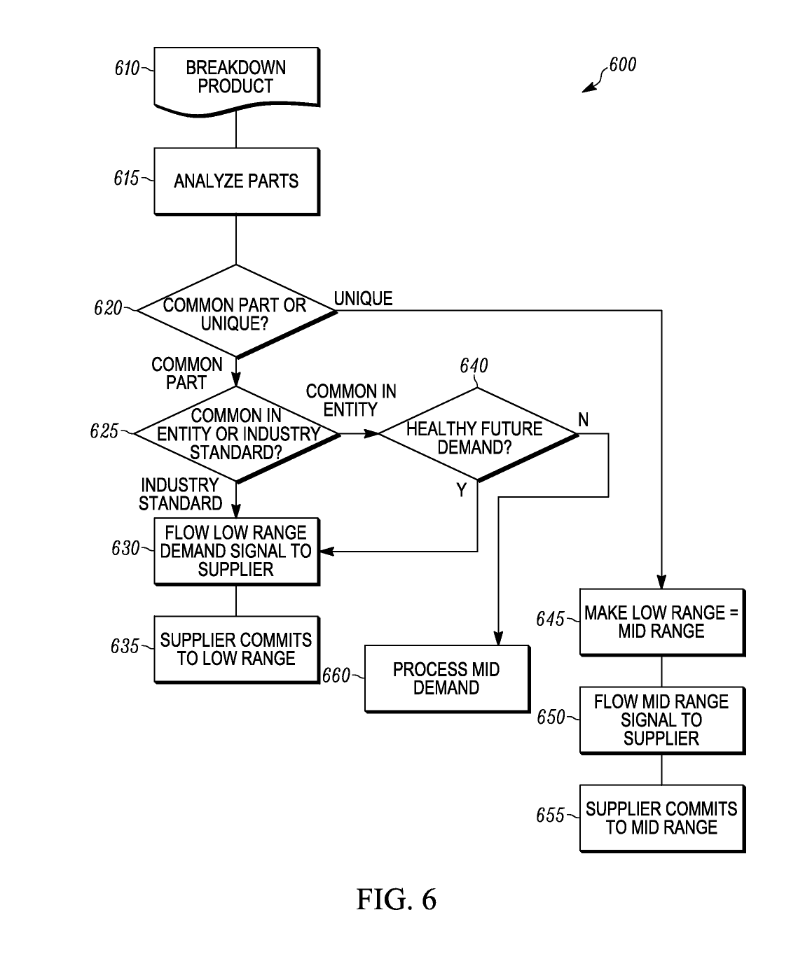

FIG. 6 is an example flowchart 600 illustrating the operation of the supply range server 200 according to a possible embodiment. The flowchart 600 can illustrate operations of processing a low demand range value in block 525 of FIG. 5 according to one embodiment. At 610, the supply range server 200 or other operations at an entity can breakdown a product into parts, sub-components, and suppliers. According to the present disclosure, the term “sub-components” includes both parts and sub-components. At 615, the supply range server 200 can analyze the sub-components to categorize the sub-components into sub-components that are industry standard, sub-components common to multiple products within an entity, and sub-components unique to a single product. In 620, the supply range server 200 can determine whether a given sub-component is a sub-component that is common to different products or a sub-component that is unique to one product. If the sub-component is common to different products, at 625, the supply range server 200 can determine whether the given sub-component is common to multiple products for an entity or is an industry standard sub-component. If the sub-component is industry standard, at 630, the supply range server 200 can flow a low range demand signal to a sub-component supplier. The low range demand signal can include a low range value for an order of sub-components. At 635, the supplier can commit to the low range value by verifying the commitment volume is only for the low range if demand drops to the low range or lower.

If the sub-component is common the multiple products for the entity, at 640, the supply range server 200 or another process or operations within the entity can determine whether there is healthy future demand for the product. If there is healthy future demand for the product, the supply range server 200 can proceed to block 630. If there is not healthy future demand for the product, at 660, the supply range server 200 can process the mid-demand range value.

If the sub-component is unique to the product at 620, then at 645, the supply range server 200 can set a low range value as a middle or base range demand value for a number of sub-components to order from the supplier. At 650, the supply range server 200 can flow a base range demand signal to a sub-component supplier. The base range demand signal can include the base range demand value for an order of sub-components from the supplier. At 655, the supplier can commit to the base range demand value by verifying the amount of sub-components will be available base range demand value.

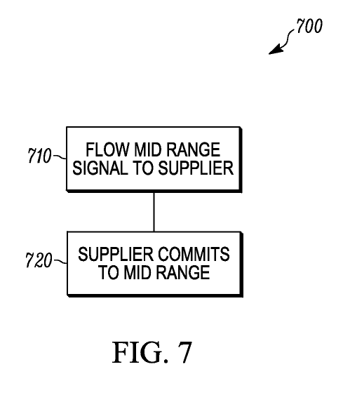

FIG. 7 is an example flowchart 700 illustrating the operation of the supply range server 200 according to a possible embodiment. The flowchart 700 can illustrate operations of processing a mid-demand range value in block 535 of FIG. 5 or in block 660 of FIG. 6 according to one embodiment. At 710, the supply range server 200 can flow a base, such as a middle, range demand signal to a sub-component supplier. The base range demand signal can include a base range value for an order of sub-components from the supplier. At 720, the supplier can commit to the base range value by verifying the amount of sub-components will be available for the base range value.

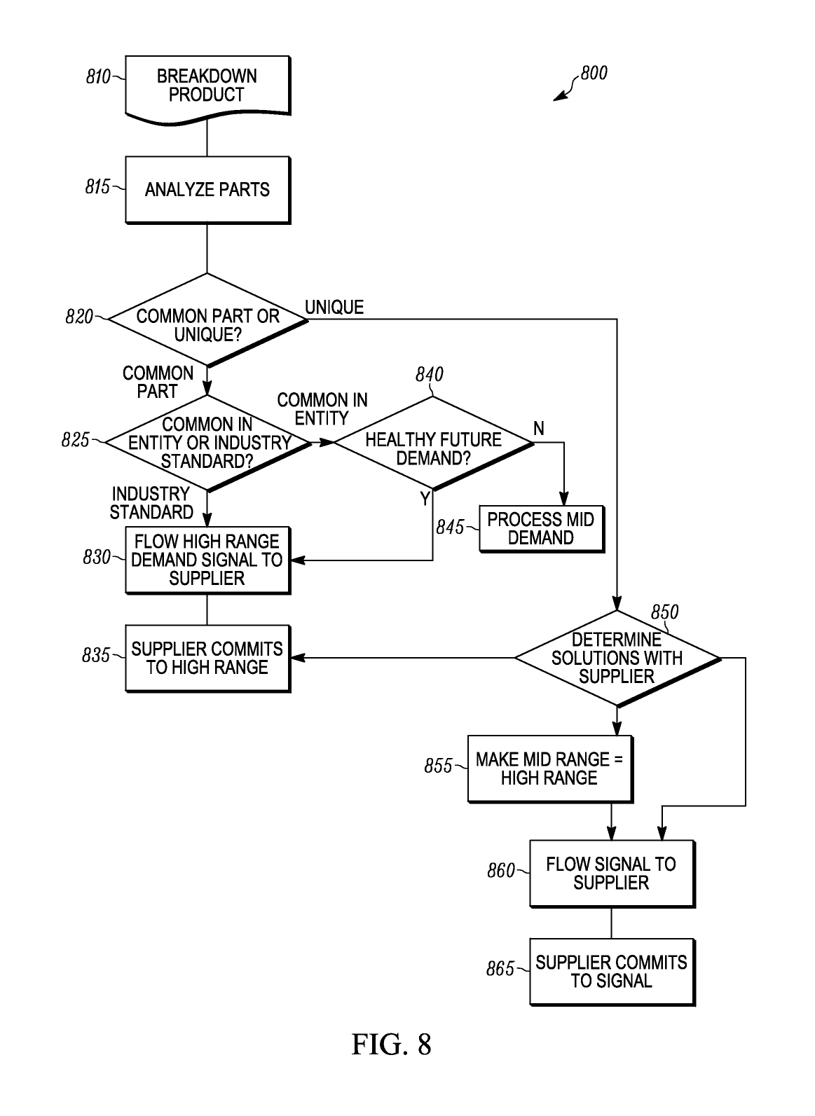

FIG. 8 is an example flowchart 800 illustrating the operation of the supply range server 200 according to a possible embodiment. The flowchart 800 can illustrate operations of processing a high demand range value in block 545 of FIG. 5 according to one embodiment. At 810, the supply range server 200 or other operations at an entity can breakdown a product into parts, sub-components, and suppliers. At 815, the supply range server 200 can analyze the sub-components to categorize the sub-components into sub-components that are industry standard, sub-components that are common to multiple products within an entity, and sub-components that are unique to a single product. In 820, the supply range server 200 can determine whether a given sub-component is a sub-component that is common to different products or a sub-component that is unique to one product. If the sub-component is common to different products, at 825, the supply range server 200 can determine whether the given sub-component is common to multiple products for an entity or is an industry standard sub-component. If the sub-component is industry standard, at 830, the supply range server 200 can flow a high range demand signal to a sub-component supplier. The high range demand signal can include a high range value for an order of sub-components.

At 835, the supplier can commit to the high range value by verifying supply availability for the intermediate product for a volume of the high range value. The commitment volume may only be to a percentage of the intermediate product volume in an extended period of time. For example, the percentage of the intermediate product volume may be a percentage of an entire part, to a percentage of a sub-component, or to a percentage of a first intermediate product based on requirements for the supplier to obtain a second intermediate product used to produce the first intermediate product. Also, the commitment volume may only be to a low range value and/or the mid-range value of the intermediate product volume if demand drops to the mid-range, the low range, or lower.

If the sub-component is common the multiple products for the entity, at 840, the supply range server 200 or another process or operations within the entity can determine whether there is healthy future demand for the product. If there is healthy future demand for the product, the supply range server 200 can proceed to block 830. If there is not healthy future demand for the product, at 845, the supply range server 200 can process the mid-demand range value.

If the sub-component is unique to the product at 820, then at 850, the producer 110 can contact the supplier 120 to determine possible solutions. The possible solutions can include making the mid-range equal to the high range for the product implementing the mid-range instead of the high range process for the product at 855. The possible solutions can also include, at 860, flowing a base or mid-range demand signal including a base or mid-range demand value, to the supplier. At 865, the supplier can commit to the requested value. The possible solutions can also include, at 835, the supplier committing to a high demand range value by verifying availability of a volume of the intermediate product for the high demand range, where the committed volume is only to a percentage of the entire part over an extended period of time.

Embodiments can provide a range of demand for an intermediate product to a supplier. Within a first portion of the part's lead time, such as a first half or a first percentage, the supplier may only build sub-components that are common to the industry/products for a low and high range. Embodiments can provide for initiating contracts with the suppliers if any material/sub-components unique to the products/industry need to be purchased to fulfill the ranges. Embodiments can provide for confirming zero to minimal liabilities if the low range actually becomes the true demand. Embodiments can provide for confirming supply availability if the high range actually becomes true demand. Embodiments can provide for collaboration with suppliers on inventory terms of low and high ranges. Embodiments can be applied to any demand and supply planning process across all industries with long lead time parts/components that contain industry standard or multiple product usage.

The method of this disclosure is preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A computer-implemented method comprising:
receiving, at a server, at least one description of an end product and a forecast demand range for the end product, the forecast demand range representing at least two demand quantities of an end product to be produced by an entity;
determining, by the server, at least one intermediate product of the end product, where the intermediate product represents a sub-component of end product, where the intermediate product is used by the entity to produce the end product;
determining, by the server, at least one common intermediate product of the at least one intermediate product, where the at least one common intermediate product is common to different end products; and
sending, from the server, a supply order request range of values representing at least two request quantity values for one order of one shipment of the common intermediate product from an intermediate product supplier, where the at least two request quantity values comprise a first request quantity value and a second request quantity value, where the first request quantity value is different from the second request quantity value.

2. The computer-implemented method according to claim 1,
wherein the first request quantity value comprises an intermediate product base supply order request value representing a base request quantity of the common intermediate product, and
wherein the second request quantity value comprises an intermediate product variation supply order request value representing a variation request quantity of the common intermediate product.

3. The computer-implemented method according to claim 2, wherein the intermediate product variation supply order request value comprises an intermediate product low supply order request value representing a low request quantity of the common intermediate product, where the intermediate product low supply order request value is lower than the intermediate product base supply order request value.

4. The computer-implemented method according to claim 3, further comprising determining whether the intermediate product is an industry standard product for the intermediate product low supply order request value,
wherein sending an intermediate product supply order request range of values includes sending the intermediate product low supply order request value if the intermediate product is an industry standard product.

5. The computer-implemented method according to claim 3, further comprising determining whether the intermediate product is a product common to multiple products for the end product producer for the intermediate product low supply order request value,
wherein sending a supply order request range of values includes sending the intermediate product low supply order request value if the intermediate product is a product common to multiple products for an end product producer.

6. The computer-implemented method according to claim 3, further comprising determining whether the intermediate product is a unique intermediate product for the end product produced by the entity,
wherein sending a supply order request range of values includes sending the intermediate product base supply order request value as the intermediate product low supply order request value if the intermediate product is a unique product for the end product produced by the entity.

7. The computer-implemented method according to claim 2, wherein the intermediate product variation supply order request value comprises an intermediate product high supply order request value representing a high request quantity of the common intermediate product, where the intermediate product high supply order request value is higher than the intermediate product base supply order request value.

8. The computer-implemented method according to claim 7, wherein sending an intermediate product supply order request range of values includes sending the intermediate product high supply order request value.

9. The computer-implemented method according to claim 7, further comprising determining whether the intermediate product is an industry standard product,
wherein sending an intermediate product supply order request range of values includes sending the intermediate product high supply order request value if the intermediate product is an industry standard product, and
wherein the method further comprises sending a commitment to purchase a percentage of the intermediate product high supply order request value number of intermediate products.

10. The computer-implemented method according to claim 7, further comprising determining whether the intermediate product is an industry standard product,
wherein sending an intermediate product supply order request range of values includes sending the intermediate product high supply order request value if the intermediate product is an industry standard product, and
wherein the method further comprises sending a commitment to purchase the intermediate product base supply order request value number of intermediate products.

11. The computer-implemented method according to claim 3, further comprising determining whether the intermediate product is a unique product produced by the entity, and
wherein sending an intermediate product supply order request range of values includes sending the intermediate product high supply order request value if the intermediate product is a unique product produced by the entity, where the intermediate product high supply order request value represents an actual intermediate product middle range value.

12. The computer-implemented method according to claim 3, further comprising determining whether the intermediate product is a unique product produced by the entity,
wherein sending an intermediate product supply order request range of values includes sending the intermediate product high supply order request value if the intermediate product is a unique product produced by the entity, and
wherein the method further comprises sending a commitment to purchase a percentage of the intermediate product high supply order request value number of intermediate products over a first period of time and a commitment to purchase all of the intermediate product high supply order request value number of intermediate products over an extended second period of time.

13. The computer-implemented method according to claim 1,
wherein sending comprises sending, from the server, a supply order request range of values representing at least three request quantity values for the common intermediate product, where the at least three request quantity values comprise a first request quantity value, a second request quantity value, and a third request quantity value, where the first request quantity value, the second request quantity value, and the third request quantity value are all different values,
wherein the first request quantity value comprises an intermediate product base supply order request value representing a base request quantity of the common intermediate product,
wherein the second request quantity value comprises an intermediate product low supply order request value representing a low request quantity of the common intermediate product, where the intermediate product low supply order request value is lower than the intermediate product base supply order request value, and
wherein the third request quantity value comprises an intermediate product high supply order request value representing a high request quantity of the common intermediate product, where the intermediate product high supply order request value is higher than the intermediate product base supply order request value.

14. The computer-implemented method according to claim 1, further comprising:
receiving, at the server, a final demand value for the end product; and
outputting, from the server, a final intermediate product commitment value based on the final demand value, where the final intermediate product commitment value comprises a commitment to order a quantity of intermediate products.

15. An apparatus comprising:
an interface that receives at least one description of an end product and a forecast demand range for the end product, the forecast demand range representing at least two demand quantities of an end product to be produced by an entity; and
a controller that determines at least one intermediate product of the end product, where the intermediate product represents a sub-component of end product, where the intermediate product is used by the at least one entity to produce the end product, where the controller further determines at least one common intermediate product of the at least one intermediate product, where the at least one common intermediate product is common to different end products, and where the controller sends a supply order request range of values representing at least two request quantity values for one order of one shipment of the common intermediate product from an intermediate product supplier, where the at least two request quantity values comprise a first request quantity value and a second request quantity value, where the first request quantity value is different from the second request quantity value.

16. The apparatus according to claim 15,
wherein the first request quantity value comprises an intermediate product base supply order request value representing a base request quantity of the common intermediate product, and
wherein the second request quantity value comprises an intermediate product variation supply order request value representing a variation request quantity of the common intermediate product.

17. The apparatus according to claim 16,
wherein the controller determines whether the intermediate product is a product common to at least one product aside from the end product, and
wherein the controller sends the supply order request range of values including the intermediate product variation supply order request value if the intermediate product is a product common to at least one product aside from the end product.

18. The apparatus according to claim 16,
wherein the controller determines whether the intermediate product is a unique intermediate product unique to the end product produced by the entity for an intermediate product low supply order request, and
wherein the controller sends the supply order request range of values including the intermediate product base supply order request value instead of the intermediate product low supply order request value if the intermediate product is a unique product unique to the end product produced by the entity.

19. The apparatus according to claim 16,
wherein the controller determines whether the intermediate product is a unique intermediate product unique to the end product produced by the entity for an intermediate product high supply order request, and
wherein the controller sends the supply order request range of values including the intermediate product base supply order request value instead of the intermediate product high supply order request value if the intermediate product is a unique product unique to the end product produced by the entity.

20. A computer-implemented method comprising:
receiving, at the server, at least one description of an end product and a forecast demand range for the end product, the forecast demand range representing at least two demand quantities of an end product to be produced by an entity;
determining, by the server, at least one intermediate product of the end product, where the intermediate product represents a sub-component of end product, where the intermediate product is used by the entity to produce the end product;
determining, by the server, at least one common intermediate product of the at least one intermediate product, where the at least one common intermediate product is common to different end products; and
sending, from the server, a supply order request range of values representing at least two request quantity values for one order of one shipment of the common intermediate product from an intermediate product supplier, where the at least two request quantity values comprise at least two of an intermediate product base supply order request value representing a potential base request quantity of the common intermediate product, an intermediate product low supply order request value representing a potential low request quantity of the common intermediate product, and an intermediate product high supply order request value representing a potential high request quantity of the common intermediate product.
